(19) United States
(12) Patent Application Publication
(10) Pub. No.: US 2019/0118462 A1
(43) Pub. Date: Apr. 25, 2019

(54) METHOD AND DEVICE FOR MANUFACTURING THREE-DIMENSIONALLY SHAPED PRODUCT

(71) Applicant: Konica Minolta, Inc., Chiyoda-ku Tokyo (JP)

(72) Inventors: Hazuki NAKAE, Kyoto-shi Kyoto (JP); Takuji HATANO, Suita-shi Osaka (JP); Takatugu SUZUKI, Hachioji-shi Tokyo (JP)

(21) Appl. No.: 16/089,660

(22) PCT Filed: Mar. 22, 2017
(86) PCT No.: PCT/JP2017/011402

§ 371 Date: Sep. 28, 2018

(30) Foreign Application Priority Data
Mar. 31, 2016 (JP) 2016-072315

(51) Int. Cl. B29C 64/165; B29C 64/393; B29C 70/18; B29C 64/268

(52) U.S. Cl. CPC B29C 64/165; B29C 64/393; B29K 2277/00; B29C 64/268; B29C 70/18

(57) ABSTRACT

A method for manufacturing a three-dimensionally shaped product, capable of obtaining a three-dimensionally shaped product having a sufficient mechanical strength without reduction in a shaping speed. A method for manufacturing a three-dimensionally shaped product includes a step of preparing a fiber sheet having a predetermined shape, a step of applying a three dimensional shaping composition to the fiber sheet, and a step of solidifying the three dimensional shaping composition applied to the fiber sheet.

### CROSS REFERENCE TO RELATED APPLICATIONS

This is the U.S. national stage of application No. PCT/JP2017/011402, filed on Mar. 22, 2017. Priority under 35 U.S.C. § 119(a) and 35 U.S.C. § 365(b) is claimed from Japanese Application No. 2016-072315, filed on Mar. 31, 2016, the disclosures all of which are also incorporated herein by reference.

### TECHNICAL FIELD

The present invention relates to a method and a device for manufacturing a three-dimensionally shaped product.

### BACKGROUND ART

Three-dimensional shaping technology (3D printing technology) for three-dimensionally arranging shaping materials based on computer aided design (CAD) data to obtain a shaped product is known.

By the way, in recent years, it has been studied to manufacture a large structure such as an automobile, an aerospace structure, or a blade of wind power generation by three-dimensional shaping technology. A three-dimensionally shaped product applied to such a large structure needs to have a high mechanical strength. However, a three-dimensionally shaped product obtained from a conventional shaping material does not have a sufficient mechanical strength.

Meanwhile, a method for manufacturing a three-dimensionally shaped product, including a step of forming a layer using a three-dimensional shaping composition containing a fibrous substance, a step of removing a solvent from the layer, a step of applying a curable binding liquid to the layer, and a step of curing a binder in the applied binding liquid to form a binding portion (for example, Patent Literature 1), is known. A three-dimensional shaping method for laminating a fiber-like molten resin containing a continuous carbon fiber while extruding the resin is also known (for example, http://www.rs.tus.ac.jp/rmatsuza/research.html).

### CITATION LIST

### Patent Literature

Patent Literature 1: JP 2015-212060 A

### SUMMARY OF INVENTION

### Technical Problem

However, according to the method of Patent Literature 1, a fibrous substance is not continuously formed, and therefore it is impossible to obtain a three-dimensionally shaped product having a sufficient mechanical strength. In addition, in the method for laminating a fiber-like molten resin containing a continuous carbon fiber while extruding the resin, a carbon fiber is continuously formed, but a shaping speed is extremely low disadvantageously.

The present invention has been achieved in view of such circumstances. An object of the present invention is to provide a method for manufacturing a three-dimensionally shaped product, capable of obtaining a three-dimensionally shaped product having a sufficient mechanical strength without reduction in a shaping speed.

### Solution to Problem

[1] A method for manufacturing a three-dimensionally shaped product, including: a step of cuffing out a fiber sheet containing a fibrous material oriented in at least one direction into a predetermined shape to form a fiber layer; and a step of applying a three-dimensional shaping composition to a surface of the fiber layer and then solidifying the three-dimensional shaping composition to form a resin layer.

[2] The method for manufacturing a three-dimensionally shaped product according to [1], in which the fibrous material is a carbon fiber.

[3] The method for manufacturing a three-dimensionally shaped product according to [1] or [2], in which the fiber sheet further contains a resin with which the fibrous material is impregnated.

[4] The method for manufacturing a three-dimensionally shaped product according to [3], in which the resin is a thermosetting resin.

[5] The method for manufacturing a three-dimensionally shaped product according to any one of [1] to [4], in which the content of the fibrous material is 10 to 30% by mass with respect to the total mass of the fiber sheet.

[6] The method for manufacturing a three-dimensionally shaped product according to any one of [1] to [5], in which the fiber sheet has a thickness of 0.05 to 0.2 mm.

[7] The method for manufacturing a three-dimensionally shaped product according to any one of [1] to [6], in which the three-dimensional shaping composition is a photocurable composition, and the step of forming the resin layer is a step of photocuring the photocurable composition applied to the fiber layer.

[8] The method for manufacturing a three-dimensionally shaped product according to any one of [1] to [7], in which the fiber sheet is cut out by laser processing.

[9] A device for manufacturing a three-dimensionally shaped product, including: a shaping stage; an ejecting unit for ejecting a three-dimensional shaping composition to the shaping stage; a first moving mechanism for changing a relative position of the ejecting unit to the shaping stage; a curing unit for curing the ejected three-dimensional shaping composition; a supply mechanism for supplying a fiber sheet to the shaping stage; a processing unit for cutting out the fiber sheet supplied onto the shaping stage into a predetermined shape; and a second moving mechanism for changing a relative position between the processing unit and the shaping stage.

### Advantageous Effects of Invention

The present invention can provide a method for manufacturing a three-dimensionally shaped product, capable of obtaining a three-dimensionally shaped product having a sufficient mechanical strength without reduction in a shaping speed.

### BRIEF DESCRIPTION OF DRAWINGS

FIG. 1A to FIG. 1D are views illustrating an example of a method for manufacturing a three-dimensionally shaped product according to the present invention.

FIG. 2A to FIG. 2D are views illustrating an example of the method for manufacturing a three-dimensionally shaped product according to the present invention.

FIG. 3 is a view illustrating an example of a three-dimensionally shaped product obtained by the method for manufacturing a three-dimensionally shaped product according to the present invention.

FIG. 4A and FIG. 4B are views illustrating an example of the configuration of a device for manufacturing a three-dimensionally shaped product.

### DESCRIPTION OF EMBODIMENTS

1. Method for Manufacturing Three-Dimensionally Shaped Product

A method for manufacturing a three-dimensionally shaped product according to the present invention includes: 1) a step of cutting out a fiber sheet into a predetermined shape to form a fiber layer; and 2) a step of applying three-dimensional shaping composition to a surface of the fiber layer and then solidifying the three-dimensional shaping composition to form a resin layer.

1-1. Regarding Step 1)

A fiber sheet is cut out into a predetermined shape to form a fiber layer.

The fiber sheet contains a fibrous material continuously oriented in at least one direction. Specifically, the fiber sheet is a woven fabric, a nonwoven fabric, a felt, or a composite fiber sheet in which each of these materials is impregnated with a resin.

Examples of the fibrous material constituting the fiber sheet include a carbon fiber, a glass fiber, an aramid fiber, a polyimide fiber, and a fluorine fiber. Among these materials, a carbon fiber is preferable because the carbon fiber has a high strength and easily obtains a shaped product with high dimensional accuracy.

The carbon fiber includes a pitch-based carbon fiber and a polyacrylonitrile (PAN)-based carbon fiber. The pitch-based carbon fiber is obtained by carbonizing pitch (petroleum, coal, or a by-product such as coal tar) as a raw material at a high temperature. The PAN-based carbon fiber is obtained by carbonizing an acrylic fiber as a raw material at a high temperature.

The fibrous material constituting the fiber sheet may be a single fiber, a filament, or a tow (a bundle of a thousand to several tens of thousands of filaments). A large tow is a bundle of 24,000 or less filaments, and a regular tow is a bundle of 40,000 or more filaments. The regular tow has low density, high specific strength, and high specific elastic modulus. The large tow is cheaper than the regular tow. The regular tow is preferable from a viewpoint of high specific strength.

The fibrous material has a diameter preferably of 5 to 40 μm, more preferably of 5 to 20 μm, still more preferably of 5 to 10 μm. In a case where the diameter of the fibrous material is 5 μm or more, a fiber strength is sufficiently high, and therefore the strength of a three-dimensionally shaped product is sufficiently increased easily. In a case where the diameter of the fibrous material is 20 μm or less, the surface smoothness of the fiber sheet is not impaired, and therefore the adhesiveness to a three-dimensional shaping composition is not easily impaired.

Among these materials, a composite fiber sheet containing a fibrous material and a resin with which the fibrous material is impregnated is preferable, and a composite carbon fiber sheet is more preferable because a three-dimensionally shaped product having a high strength is easily obtained. Examples of the composite carbon fiber sheet include a carbon fiber reinforced plastic and a carbon fiber reinforced carbon composite material.

The resin contained in the composite fiber sheet is a thermoplastic resin or a thermosetting resin. Examples of the thermosetting resin include an epoxy resin, an unsaturated polyester, a vinyl ester resin, a bismaleimide resin, a phenol resin, a cyanate resin, and a thermosetting polyimide resin. Examples of the thermoplastic resin include polyamide (PA), polyacetal, polyacrylate, polysulfone, ABS, polyester, acrylic, polybutylene terephthalate (PBT), polycarbonate (PC), polyethylene terephthalate (PET), polyethylene, polypropylene, polyphenylene sulfide (PPS), polyetheretherketone (PEEK), polyetherimide (PEI), polyetherketone (PEK), vinyl chloride, a fluorine-based resin (polytetrafluoroethylene and the like), and silicone. Polyamide (PA), polyphenylene sulfide (PPS), polyetheretherketone (PEEK), polyetherimide (PEI), and polyetherketone (PEK) are preferable from viewpoints of adhesiveness to a fibrous material and mechanical properties as a matrix resin.

Among these resins, the resin contained in the composite fiber sheet is preferably a thermosetting resin from a viewpoint of easily obtaining a three-dimensionally shaped product having favorable adhesiveness to a resin layer formed of a cured product of a photocurable composition, a high strength, and less warpage after storage at a high temperature. In addition, a thermoplastic resin is preferable from a viewpoint of easily obtaining a three-dimensionally shaped product having favorable adhesiveness to a resin layer formed of a solidified product of a thermoplastic resin composition and favorable impact resistance. Among these resins, in the present invention, a thermosetting resin is preferable, and an epoxy resin is more preferable from a viewpoint of easily obtaining a three-dimensionally shaped product having favorable adhesiveness to a resin layer formed of a cured product of a photo curable composition, a high strength, and less warpage after storage at a high temperature.

The content of the fibrous material is preferably 1 to 50% by mass with respect to the total mass of the fiber sheet. In a case where the content of the fibrous material is 1% by mass or more, the strength of the three-dimensionally shaped product can be sufficiently increased. In a case where the content of the fibrous material is 50% by mass or less, adhesiveness between the fiber layer and the resin layer is not easily impaired, and a difference in elastic modulus does not become too large. Therefore, warpage at a high temperature can be suppressed. The content of the fibrous material is more preferably 5 to 40% by mass, and still more preferably 10 to 30% by mass with respect to the total mass of the fiber sheet.

The fiber sheet preferably has a thickness of 0.1 to 1 mm, for example. In a case where the thickness of the fiber sheet is 0.1 mm or more, a sufficient strength can be easily imparted to a three-dimensionally shaped product. In a case where the thickness of the fiber sheet is 1 mm or less, processability in laser processing to a desired shape is not easily impaired. The thickness of the fiber sheet is more preferably 0.05 to 0.2 mm.

Cut-out of the fiber sheet can be performed by laser processing, cutting with diamond grindstone, or cutting with high pressure water. Among these methods, laser processing is preferable because of less influence on the fiber sheet and high accuracy.

Examples of laser processing include an ultrashort pulse laser processing and a fiber laser processing. Among these methods, fiber laser processing is preferable because of less influence on peripheral parts, and high-power fiber laser processing is more preferable in terms of shortening processing time. In this way, the shaping speed can be improved by using the fiber sheet.

1-2. Regarding Step 2)

A three-dimensional shaping composition is applied to a surface of the obtained fiber layer, and then the composition is solidified to form a resin layer.

The thickness of the resin layer can be about ½ to 10 times the thickness of the fiber layer. In a case where the thickness of the resin layer is 50% or more, adhesiveness between the fiber layer and the resin layer of the obtained three-dimensionally shaped product tends to be favorable. In a case where the thickness of the resin layer is 300% or less, it is easy to obtain a three-dimensionally shaped product having a high strength.

A method for forming the resin layer is not particularly limited and may be stereolithography (STL method), a material jetting method, fused deposition modeling (FDM method), or a selective laser sintering (SLS method).

The stereolithography is a method for irradiating only a desired portion of a liquid surface of a tank filled with a liquid photocurable composition with light to form a resin layer on a shaping stage in the tank. The material jetting method is a method for irradiating a liquid photocurable composition sprayed from an inkjet head with light and curing the composition to form a resin layer.

The fused deposition modeling method (FDM method) is a method for extruding a thermoplastic resin composition from a head (nozzle) while the composition is melted and then cooling the composition to form a resin layer. The selective laser sintering method (SLS method) is a method for spraying a thermoplastic resin powder and then baking the powder with a laser to form a resin layer.

In the stereolithography (STL method) and the material jetting method, a photocurable composition is preferably used. In the fused deposition modeling method (FDM method) and the selective laser sintering method (SLS method), a thermoplastic resin composition is preferably used.

1-2-1. Case where Three-Dimensional Shaping Composition is Photocurable Composition

The photocurable composition is applied to a surface of the obtained fiber layer. Thereafter, the photocurable composition is irradiated with light and cured to form a resin layer.

The photocurable composition may be applied, for example, by disposing a movable shaping stage having a fiber layer disposed thereon in a tank filled with a liquid photocurable composition (stereolithography), or by ejecting a liquid photocurable composition onto a fiber layer by an inkjet method (material jetting method).

The light with which the photocurable composition is irradiated is preferably an ultraviolet ray. The peak wavelength of the ultraviolet ray is preferably 340 nm or more and 400 nm or less, and more preferably 350 nm or more and 380 nm or less.

The irradiation intensity/irradiation dose of light only needs to be able to sufficiently cure the photocurable composition. The irradiation intensity may be, for example, 0.1 to 10 W/cm², and the irradiation dose may be, for example, 50 to 1,000 mJ/cm².

Then, the photocurable composition in a region which has not been irradiated with light is removed. Examples of a method for removing the photocurable composition in a region which has not been irradiated with light include a method for removing an uncured portion with a brush or the like, a method for sucking and removing an uncured portion, a method for blowing a gas such as air, a method for applying a liquid such as water (for example, a method for immersing an obtained laminate in a liquid or a method for spraying a liquid), and a method for applying vibration such as ultrasonic vibration. In addition, it is possible to combine two or more methods selected from these methods. More specific examples thereof include a method for blowing a gas such as air and then immersing an obtained laminate in a liquid such as water and a method for applying ultrasonic vibration while an obtained laminate is immersed in a liquid such as water. Among these methods, a method for applying a liquid containing water to an obtained laminate (particularly a method for immersing an obtained laminate in a liquid containing water) is preferable.

(Photocurable Composition)

The photocurable composition includes a photopolymerizable compound and a photopolymerization initiator. The photopolymerizable compound may be a photocationically polymerizable compound (for example, an epoxy compound, a vinyl ether compound, or an oxetane compound) or a photoradically polymerizable compound (for example, a (meth)acrylate compound). The photoradically polymerizable compound is preferable.

The photoradically polymerizable compound has an ethylenically unsaturated double bond. The compound having an ethylenically unsaturated double bond includes an unsaturated carboxylic acid (for example, acrylic acid, methacrylic acid, itaconic acid, crotonic acid, isocrotonic acid, or maleic acid), esters thereof, and amides thereof. An ester of an unsaturated carboxylic acid is preferable, and a (meth)acrylate is more preferable. The (meth)acrylate may be monofunctional or polyfunctional.

Examples of the monofunctional (meth)acrylate include tolyloxyethyl (meth)acrylate, phenyloxyethyl (meth)acrylate, cyclohexyl (meth)acrylate, ethyl (meth)acrylate, methyl (meth)acrylate, isobornyl (meth)acrylate, tetrahydrofurfuryl (meth)acrylate, 2-(2-vinyloxyethoxy) ethyl acrylate, and 2-hydroxy-3-phenoxypropyl acrylate.

Examples of the difunctional (meth)acrylate include ethylene glycol di(meth)acrylate, triethylene glycol di(meth)acrylate, dipropylene glycol di(meth)acrylate, 4-hydroxybutyl acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexanediol di(meth)acrylate, tetraethylene glycol di(meth)acrylate, pentaerythritol di(meth)acrylate, and dipentaerythritol di(meth)acrylate.

Examples of the trifunctional (meth)acrylate include trimethylolpropane tri(meth)acrylate, trimethylolethane tri(meth)acrylate, alkylene oxide-modified tri(meth)acrylate of trimethylolpropane, pentaerythritol tri(meth)acrylate, dipentaerythritol tri(meth)acrylate, trimethylolpropane tri((meth)acryloyloxypropyl) ether, isocyanuric acid alkylene oxide-modified tri(meth)acrylate, propionic acid dipentaerythritol tri(meth)acrylate, tri((meth)acryloyloxyethyl) isocyanurate, hydroxypivalaldehyde-modified dimethylol propane tri(meth)acrylate, and sorbitol tri(meth)acrylate.

The content of the photopolymerizable compound is preferably 80% by mass or more, and more preferably 85% by mass or more with respect to the photocurable composition.

The photopolymerization initiator is a photocationic polymerization initiator or a photoradical polymerization initiator. The photopolymerizable compound is preferably a photoradically polymerizable compound. Therefore, the photopolymerization initiator is preferably a photoradical polymerization initiator. The photoradical polymerization initiator includes an intramolecular bond cleavage type initiator and an intramolecular hydrogen abstraction type initiator.

Examples of the intramolecular bond cleavage type photopolymerization initiator include: an acetophenone-based initiator such as diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy) phenyl-(2-hydroxy-2-propyl) ketone, 1-hydroxycyclohexyl-phenyl ketone, 2-methyl-2-morpholino (4-thiomethylphenyl) propan-1-one, or 2-benzyl-2-dimethylamino-1-(4-morpholinophenyl)-butanone; a benzoin such as benzoin, benzoin methyl ether, or benzoin isopropyl ether; an acylphosphine oxide-based initiator such as 2,4,6-trimethylbenzoin diphenylphosphine oxide or bis(2,4,6-trimethylbenzoyl)-phenylphosphine oxide; benzyl; and a methylphenyl glyoxy ester.

Examples of the intramolecular hydrogen abstraction type photopolymerization initiator include: a benzophenone-based initiator such as benzophenon, methyl o-benzoylbenzoate-4-phenylbenzophenone, 4,4′-dichlorobenzophenone, hydroxybenzophenone, 4-benzoyl-4′-methyl-diphenylsulfide, acrylated benzophenone, 3,3′,4,4′-tetra(t-butylperoxycarbonyl) benzophenone, or 3,3′-dimethyl-4-methoxybenzophenone; a thioxanthone-based initiator such as 2-isopropylthioxanthone, 2,4-dimethylthioxanthone, 2,4-diethylthioxanthone, or 2,4-dichlorothioxanthone; an aminobenzophenone-based initiator such as Michler's ketone or 4,4′-diethylaminobenzophenone; 10-butyl-2-chloroacridone; 2-ethylanthraquinone; 9,10-phenanthrenequinone; and camphorquinone.

The content of the photopolymerization initiator is preferably 0.01% by mass to 15% by mass, and more preferably 0.1 to 10% by mass with respect to the photopolymerizable compound.

The photocurable composition may further contain another component, if necessary. Examples of the other component include various colorants (a pigment, a dye, and the like), a dispersant, a surfactant, a polymerization accelerator, a sensitizer, a solvent, a penetration accelerator, a humectant (a moisturizing agent), an adhesion accelerator, a fungicide, an antiseptic, an antioxidant, an ultraviolet absorber, a chelating agent, a pH regulator, an anticoagulant, and an antifoaming agent.

The viscosity of the photocurable composition at 25° C. is preferably 1 mPa·s or more and 150 mPa·s or less, and more preferably 3 mPa·s or more and 50 mPa·s or less because the photocurable composition can be stably ejected by an inkjet method. The viscosity of the photocurable composition can be measured with an E type viscometer.

1-2-2. Case where Three-Dimensional Shaping Composition is Thermoplastic Resin Composition

A thermoplastic resin composition is applied to a surface of the obtained fiber layer, and then the thermoplastic resin composition is cooled and solidified to form a resin layer.

For example, a thermoplastic resin composition melted by heat may be extruded from a nozzle, and then the molten thermoplastic resin composition may be cooled and solidified. Alternatively, a powdery thermoplastic resin may be sprayed from a nozzle, and then the thermoplastic resin composition may be irradiated with laser light to be sintered and solidified.

(Thermoplastic Resin Composition)

The thermoplastic resin composition contains a thermoplastic resin. Examples of the thermoplastic resin include an acrylonitrile/butadiene/styrene copolymer (ABS resin), a polylactic acid (PLA resin), a polyolefin resin (for example, polyethylene or polypropylene), a polyester other than a polylactic acid, a polyamide (for example, nylon 6 or nylon 6,6), polycarbonate, polyacetal, modified products thereof, and elastomers thereof. Among these compounds, a polylactic acid is preferable from a viewpoint of favorable biodegradability or the like.

The polylactic acid may be a homopolymer of lactic acid or a copolymer of lactic acid and another copolymerization component. Examples of the other copolymerization component include a polycarboxylic acid, a polyhydric alcohol, a hydroxycarboxylic acid, and a lactone. Specific examples thereof include a polycarboxylic acid such as oxalic acid, malonic acid, succinic acid, glutaric acid, adipic acid, azelaic acid, sebacic acid, dodecanedioic acid, fumaric acid, cyclohexanedicarboxylic acid, terephthalic acid, isophthalic acid, phthalic acid, 2,6-naphthalenedicarboxylic acid, 5-sodium sulfoisophthalic acid, or 5-tetrabutylphosphonium sulfoisophthalic acid; ethylene glycol, propylene glycol, butanediol, heptanediol, hexanediol, octanediol, nonanediol, decanediol, 1,4-cyclohexanedimethanol, neopentyl glycol, glycerin, trimethylolpropane, pentaerythritol, bisphenol A, and an aromatic polyhydric alcohol obtained by an addition reaction of ethylene oxide to bisphenol A; a polyhydric alcohol such as diethyleneglycol, triethyleneglycol, polyethyleneglycol, polypropyleneglycol, or polytetramethyleneglycol; a hydroxycarboxylic acid such as glycolic acid, 3-hydroxybutyric acid, 4-hydroxybutyric acid, 4-hydroxyvaleric acid, 6-hydroxycaproic acid, or hydroxybenzoic acid; and a lactone such as glycolide, ε-caprolactone glycolide, ε-caprolactone, β-propiolactone, δ-butyrolactone, β- or γ-butyrolactone, pivalolactone, or δ-valerolactone.

A content ratio of a structural unit derived from such a copolymerization component is preferably 0 to 30% by mol, and more preferably 0 to 10% by mol with respect to the total 100% by mol of structural units of monomers constituting a polylactic acid.

The thermoplastic resin composition may further contain another component, if necessary. Examples of the other component include a plasticizer and a stabilizer in addition to other components similar to those described above.

The thermoplastic resin composition can be obtained, for example, by blending appropriate amounts of components and melt-kneading the components. Melt-kneading is preferably performed using a single screw extruder or a twin screw extruder including a heating device and a vent port. The heating temperature during melt-kneading is usually preferably 170 to 260° C., and more preferably 150° C. to 250° C.

The shape of the thermoplastic resin composition is not particularly limited but is a filament, a pellet, or a powder.

The three-dimensionally shaped product in the present invention can be obtained by repeating the steps 1) and 2). The order of the steps 1) and 2) does not matter. For example, the step 2) may be performed after the step 1), or the step 1) may be performed after the step 2). The steps 1) and 2) may be performed alternately, or the step 2) may be performed a plurality of times for one time of the step 1). In this way, by repeating the steps 1) and 2), a three-dimensionally shaped product can be obtained.

In addition, a cured product of a photocurable composition has a higher strength (elastic modulus) than a solidified product of a thermoplastic resin composition. Therefore, in order to suppress warpage caused by a difference in elastic modulus between the fiber layer and the resin layer, the resin layer is preferably a cured product of a photocurable composition.

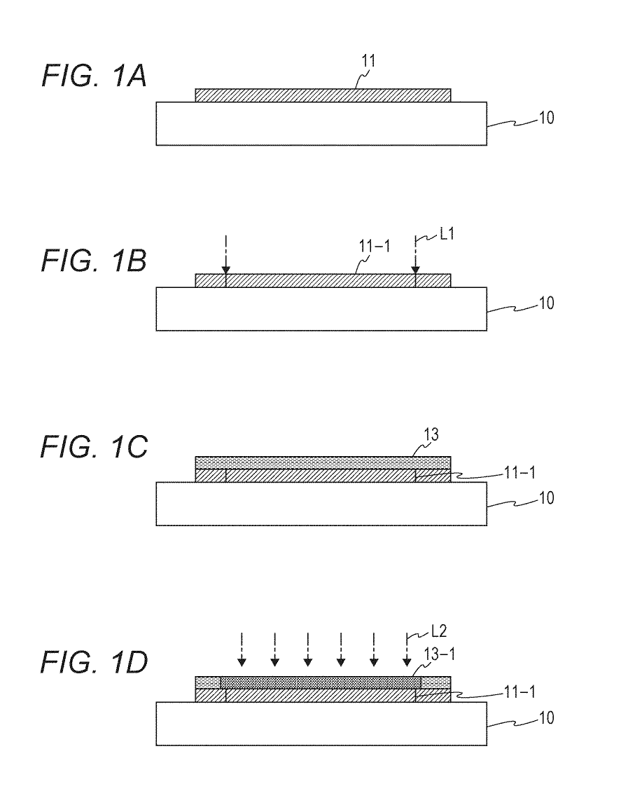

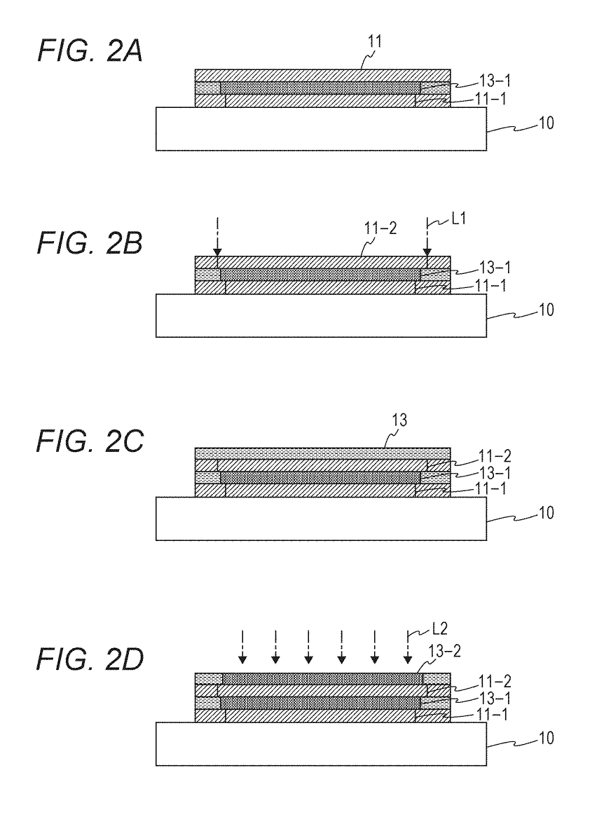

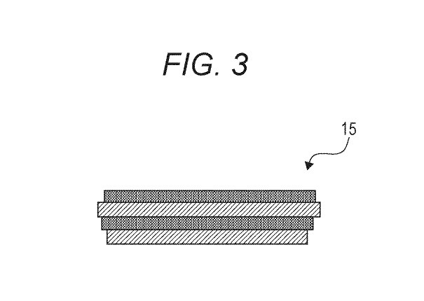

FIG. 1A TO FIG. 1D and FIG. 2A TO FIG. 2D are views illustrating an example of a method for manufacturing a three-dimensionally shaped product according to the present invention. FIG. 3 is a view illustrating an example of a three-dimensionally shaped product obtained by the method for manufacturing a three-dimensionally shaped product according to the present invention. The drawings illustrate an example in which the three-dimensional shaping composition is a photocurable composition. For example, a fiber sheet 11 is disposed on a shaping stage 10, and the fiber sheet 11 is cut into a predetermined shape with laser light L1 to obtain a fiber layer 11-1 (the above step 1), see FIG. 1A and FIG. 1B). A photocurable composition 13 is applied onto the fiber layer 11-1 (or the fiber sheet 11) (see FIG. 1C). Thereafter, a predetermined region of the photocurable composition 13 is irradiated with light L2 and cured to obtain a cured product layer (resin layer) 13-1 (the above step 2), see FIG. 1D). The fiber sheet 11 is further disposed on the cured product layer (resin layer) 13-1 and cut into a predetermined shape with the laser light L1 to obtain a fiber layer 11-2 (the above step 1), see FIG. 2A and FIG. 2B). The photocurable composition 13 is applied onto the fiber layer 11-2 (or the fiber sheet 11) (see FIG. 2C). Thereafter, a predetermined region of the photocurable composition 13 is irradiated with light L2 and cured to obtain a cured product layer (resin layer) 13-2 (the above step 2), see FIG. 2D). After completion of lamination, an outer peripheral portion cut out from the fiber sheet 11 and an uncured portion of the photocurable composition 13 are removed to obtain a three-dimensionally shaped product 15 (see FIG. 3).

A three-dimensionally shaped product obtained by using a composite fiber sheet may have a structure in which a fiber layer and a resin layer are alternately laminated.

The content of a fibrous material in the obtained three-dimensionally shaped product is preferably 5 to 60% by mass with respect to the total mass of the three-dimensionally shaped product. In a case where the content of the fibrous material is 5% by mass or more with respect to the total mass of the three-dimensionally shaped product, the strength of the three-dimensionally shaped product is easily increased. In a case where the content of the fibrous material is 60% by mass or less, adhesiveness between the fiber layer and the resin layer, strength, and shaping accuracy are hardly impaired. The content of the fibrous material is more preferably 10 to 30% by mass with respect to the total mass of the three-dimensionally shaped product from viewpoints of strength and shaping accuracy.

A three-dimensionally shaped product obtained by the method for manufacturing a three-dimensionally shaped product according to the present invention has a high strength. Therefore, the three-dimensionally shaped product can be preferably used for applications requiring a high strength, such as a large-sized structure.

2. Device for Manufacturing Three-Dimensionally Shaped Product

The method for manufacturing a three-dimensionally shaped product according to the present invention can be performed using, for example, an inkjet type device for manufacturing a three-dimensionally shaped product.

A device for manufacturing a three-dimensionally shaped product according to the present invention includes: a shaping stage; an ejecting unit for ejecting a three-dimensional shaping composition to the shaping stage; a first moving mechanism for changing a relative position of the ejecting unit to the shaping stage; a curing unit for curing the ejected three-dimensional shaping composition; a supply mechanism for supplying a fiber sheet to the shaping stage; a processing unit for cutting out the fiber sheet supplied onto the shaping stage into a predetermined shape; and a second moving mechanism for changing a relative position between the processing unit and the shaping stage.

The ejecting unit, the curing unit, and the processing unit may be disposed individually or integrally.

For example, in a case where the three-dimensional shaping composition is a photocurable composition, the curing unit is a light irradiation unit. For example, in a case where the three-dimensional shaping composition is a thermoplastic resin composition, the curing unit is a cooling unit or a laser light irradiation unit. In a case where the curing unit is a laser light irradiation unit, the curing unit may also serve as a processing unit.

The first moving mechanism for changing a relative position of the ejecting unit to the shaping stage and the second moving mechanism for changing a relative position between the processing unit and the shaping stage may be disposed individually, or one mechanism may be disposed for combined use thereof.

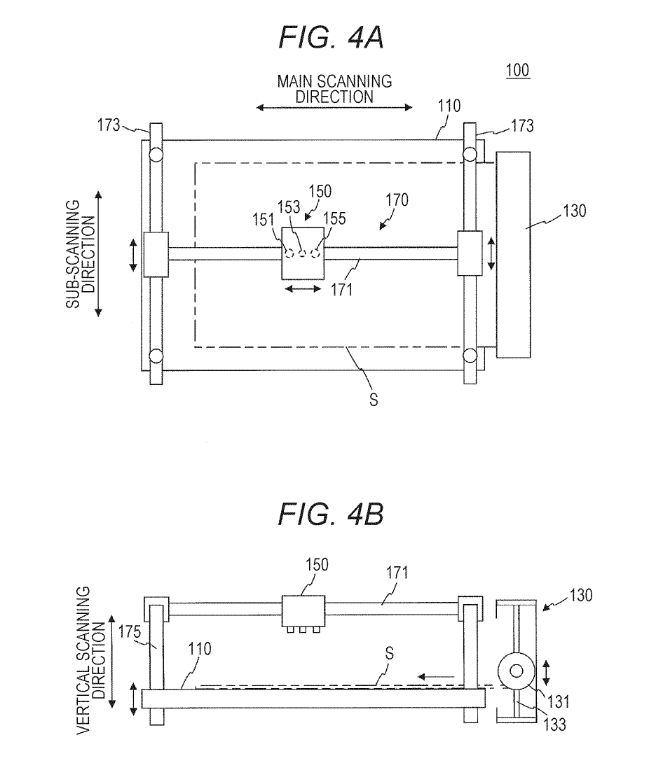

FIG. 4A is a plan view illustrating an example of the configuration of a device for manufacturing a three-dimensionally shaped product according to the present invention, and FIG. 4B is a front view of FIG. 4A. FIG. 4A and FIG. 4B illustrate an example in which a photocurable composition is used as a three-dimensional shaping composition. As illustrated in FIG. 4A and FIG. 4B, a device 100 for manufacturing a three-dimensionally shaped product includes a shaping stage 110, a fiber sheet supply mechanism 130, a head block 150, and a moving mechanism 170 for the head block 150 (first moving mechanism and second moving mechanism).

The shaping stage 110 is disposed below the head block 150 and is movable in the vertical direction.

The fiber sheet supply mechanism 130 supplies a predetermined number of fiber sheets S to the shaping stage 110. The fiber sheet supply mechanism 130 includes, for example, a roll body 131 of the fiber sheet S and a support member 133 for supporting the roll body 131 so as to be movable up and down (see FIG. 4B). As a result, the fiber sheet supply unit 130 drives a driving mechanism (not illustrated) based on control information from a controller (not illustrated) and supplies the fiber sheet S to an arbitrary height of the shaping stage 110. Thereafter, the fiber sheet S is cut by a cutting unit (not illustrated).

The device 100 for manufacturing a three-dimensionally shaped product may further include a removal unit (not illustrated) for removing the cut fiber sheet S from the shaping stage 110, if necessary. The removal unit may be, for example, an air blowing unit, a removing arm, or the like.

The head block 150 includes a processing unit 151, an ejecting unit 153, and a curing unit 155.

The processing unit 151 emits laser light and cuts the fiber sheet S disposed on the shaping stage 110 into a predetermined shape. The specific configuration of the processing unit 151 using laser light can be similar to the configuration described in, for example, JP 2015-47638 A.

The ejecting unit 153 is an inkjet type ejection head having a plurality of ejection nozzles arranged in a row in a longitudinal direction (sub-scanning direction). The ejecting unit 153 selectively ejects droplets of a photocurable composition from the plurality of ejection nozzles toward the shaping stage 110 while scanning the shaping stage 110 in a main scanning direction orthogonal to the longitudinal direction. This operation is repeated a plurality of times while the ejecting unit 153 is shifted in the sub-scanning direction, and a resin layer is thereby formed in a desired region on the shaping stage 110. As the ejecting unit 153, a conventionally known inkjet head for image formation is used. The plurality of ejection nozzles only needs to be arranged in a row and may be arranged linearly or in a zigzag pattern so as to be linear as a whole.

The curing unit 155 irradiates the droplets of the photocurable composition ejected toward the shaping stage 110 with light to cure the photocurable composition. Examples of the curing unit 155 include a high pressure mercury lamp for emitting ultraviolet rays (UV), a low pressure mercury lamp, a medium pressure mercury lamp, an ultrahigh pressure mercury lamp, a carbon arc lamp, a metal halide lamp, a xenon lamp, and an ultraviolet LED lamp.

The moving mechanism 170 (first moving mechanism and second moving mechanism) three-dimensionally changes a relative position between the head block 150 and the shaping stage 110. Specifically, the moving mechanism 170 includes a main scanning direction guide 171 engaged with the head block 150, a sub-scanning direction guide 173 for guiding the main scanning direction guide 171 in the sub-scanning direction, and a vertical direction guide 175 for guiding the shaping stage 110 in the vertical direction, and further includes a driving mechanism including a motor, a drive reel, and the like (not illustrated). Specifically, the moving mechanism 170 drives a motor and a driving mechanism (both are not illustrated) according to control information output from a controller (not illustrated), and freely moves the head block 150 in the main scanning direction and the sub-scanning direction (see FIG. 4A) or moves the shaping stage 110 in the vertical direction (see FIG. 4B).

Hereinafter, a method for manufacturing a three-dimensionally shaped product using the device 100 for manufacturing a three-dimensional shaped product will be described. First, the fiber sheet supply unit 130 supplies a predetermined number of the fiber sheets S onto the shaping stage 110 based on the control information from the controller (not illustrated). Then, the processing unit 151 of the head block 150 performs laser processing of the fiber sheet S into a predetermined shape based on the control information from the controller (not illustrated) to form a fiber layer (the above step 1)).

Subsequently, the ejecting unit 153 of the head block 150 ejects the photocurable composition from each ejection nozzle based on slice data while scanning from one end (a reference position serving as a starting point of scanning in the main scanning direction) on the shaping stage 110 in the main scanning direction to the other end (a reference position serving as an end point of scanning in the main scanning direction) based on the control information from the controller (not illustrated). At the same time, the curing unit 155 of the head block 150 irradiates the ejected photocurable composition with light to cure the photocurable composition (the above step 2), operation A). The head block 150 moves in the sub-scanning direction such that the ejection positions of the photocurable composition by the ejecting unit 153 do not overlap each other while stopping ejection of the photocurable composition (operation B). By repeating the operations A and B, a predetermined region on the shaping stage 110 can be scanned, and one resin layer can be formed.

After the resin layer is formed, the shaping stage 110 moves in the vertical direction by a pitch (laminating pitch) according to the thickness of one resin layer or one fiber layer (operation C). By repeating these operations A to C, a three-dimensionally shaped product can be obtained.

Note that the above embodiment illustrates an example in which the processing unit 151 is a laser processing unit. However, the processing unit 151 is not limited thereto and may be a cutting processing unit with diamond grindstone or a cutting processing unit with high pressure water.

The above embodiment illustrates an example in which one moving mechanism 170 serves as both the first moving mechanism for changing a relative position of the ejecting unit 153 to the shaping stage 110 and the second moving mechanism for changing a relative position between the processing unit 151 and the shaping stage 110. However, the present invention is not limited thereto, and the first moving mechanism and the second moving mechanism may be disposed individually.

The above embodiment illustrates an example in which the processing unit 151, the ejecting unit 153, and the curing unit 155 are integrally disposed. However, the present invention is not limited thereto, and the processing unit 151, the ejecting unit 153, and the curing unit 155 may be disposed individually.

The above embodiment illustrates an example in which the moving mechanism 170 changes a relative position between the head block 150 and the shaping stage 110 by moving the head block 150, but the present invention is not limited thereto. For example, the relative position between the head block 150 and the shaping stage 110 may be changed by fixing the position of the head block 150 and moving the shaping stage 110 in the main scanning direction and the sub-scanning direction, or both the head block 150 and the shaping stage 110 may be movable. The moving mechanism 170 may move the head block 150 upward in the vertical direction by fixing the position of the shaping stage 110 in the vertical direction, or may move both the shaping stage 110 and the head block 150.

### EXAMPLES

Hereinafter, the present invention will be specifically described with reference to Examples, but the present invention is not limited thereto.

1. Three-dimensional shaping composition

### (1) Preparation of Photocurable Composition

The following components were mixed to obtain a photocurable composition.

### (Photopolymerizable Compound)

2-(2-Vinyloxyethoxy) ethyl acrylate: 31 parts by mass

Phenoxyethyl acrylate: 11 parts by mass

2-Hydroxy-3-phenoxypropyl acrylate: 14 parts by mass

Dipropylene glycol diacrylate: 15 parts by mass

4-Hydroxybutyl acrylate: 20 parts by mass

### (Photopolymerization Initiator)

Bis(2,4,6-trimethylbenzoyl)-phenylphosphine oxide: 5 parts by mass

2,4,6-Trimethylbenzoyl-diphenyl-phosphine oxide: 4 parts by mass

### (Sensitizer)

1,4-Bis-(benzoxazoyl-2-yl) naphthalene: 0.25 parts by mass

The viscosity of the obtained photocurable composition at 25° C. was 18 mPa·s.

2. Fiber Sheet

Fiber sheets 1 to 10 illustrated in the following Table 1 were prepared.

TABLE 1

| Fiber | | Fibrous | | | Thickness | Content ratio of fibrous |
|---|---|---|---|---|---|---|
| sheet No. | Trade name | material | Fiber diameter (μm) | Resin | (mm) | material (% by mass) |
| 1 | PYROFIL prepreg | Carbon fiber | 7 to 10 | #395 (Epoxy resin) | 0.10 | 10.5 |
| | Tough-QURE ™ | | | | | |
| 2 | PYROFIL prepreg | Carbon fiber | 7 to 10 | #395 (Epoxy resin) | 0.10 | 11.1 |
| | Tough-QURE ™ | | | | | |
| 3 | Tomifleck F | Fluorine fiber | 35 | — | 0.10 | 100 |
| | (manufactured by | | | | | |
| | Tomoegawa Co., Ltd., | | | | | |
| | porous sheet) | | | | | |
| 4 | PYROFIL prepreg | Carbon fiber | 7 to 10 | #395 (Epoxy resin) | 0.20 | 21.0 |
| | Tough-QURE ™ | | | | | |
| 5 | PYROFIL prepreg | Carbon fiber | 7 to 10 | #395 (Epoxy resin) | 0.10 | 29.1 |
| | Tough-QURE ™ | | | | | |
| 6 | PYROFIL prepreg | Carbon fiber | 7 to 10 | #395 (Epoxy resin) | 0.10 | 35.2 |
| | Tough-QURE ™ | | | | | |
| 7 | PYROFIL prepreg | Carbon fiber | 7 to 10 | #395 (Epoxy resin) | 0.10 | 5.2 |
| | Tough-QURE ™ | | | | | |
| 8 | TEPEX ® | Carbon fiber | 7 to 10 | Thermoplastic resin | 0.10 | 10.5 |
| 9 | PYROFIL prepreg | Carbon fiber | 7 to 10 | #395 (Epoxy resin) | 0.24 | 25.2 |
| | Tough-QURE ™ | | | | | |
| 10 | PYROFIL prepreg | Carbon fiber | 7 to 10 | #395 (Epoxy resin) | 0.08 | 8.4 |
| | Tough-QURE ™ | | | | | |

3. Manufacture of Three-Dimensionally Shaped Product

### Example 1

Using the prepared photocurable composition, a strip-shaped three-dimensionally shaped product having a length of 170 mm, a width of 20 mm, and a thickness of 5 mm was manufactured by a material jetting method. Specifically, the prepared photocurable composition was ejected onto a shaping stage by an inkjet method. A predetermined region of the ejected photocurable composition was irradiated with ultraviolet rays at an irradiation intensity of 5 W/cm² at an irradiation dose of 500 mJ/cm² and cured to obtain a resin layer having a thickness of 0.9 mm.

Subsequently, the fiber sheet 1 was disposed on the obtained resin layer, subjected to laser processing using a 3 kW single mode fiber laser device (maximum output 3 kW, beam diameter 40 μm), and cut into a predetermined shape to obtain a fiber layer having a thickness of 0.1 mm (the above step 1)). Furthermore, the photocurable composition was ejected onto the entire surface of the obtained fiber layer by an ink jet method, and a predetermined region of the ejected photocurable composition was irradiated with ultraviolet rays and cured to obtain a resin layer having a thickness of 0.9 mm (the above step 2)). The steps 1) and 2) were repeated to obtain a three-dimensionally shaped product.

The obtained three-dimensionally shaped product had a laminated structure (four fiber layers and five resin layers) of resin layer (0.9 mm)/fiber layer (0.1 mm)/resin layer (0.9 mm)/fiber layer (0.1 mm)/resin layer (0.9 mm)/fiber layer (0.1 mm)/resin layer (0.9 mm)/fiber layer (0.1 mm)/resin layer (0.9 mm).

### Example 2

Using the prepared thermoplastic resin composition, a strip-shaped three-dimensionally shaped product having a length of 170 mm, a width of 20 mm, and a thickness of 5 mm was manufactured by a thermal melting lamination method (FDA method). Specifically, a PLA filament (polylactic acid filament) manufactured by German RepRap Co., Ltd. was set in a 3D printer (zortrax M200). Then, the fiber sheet 2 was disposed on the shaping stage and was subjected to laser processing so as to obtain a predetermined shape to obtain a fiber layer having a thickness of 0.1 mm (the above step 1)). Subsequently, the filament was melted in a nozzle of a 3D printer set at a nozzle temperature of 220° C., ejected onto the obtained fiber layer, and then cooled and solidified to obtain a resin layer having a thickness of 1 mm (the above step 2)). These steps were repeated to obtain a three-dimensionally shaped product.

### Examples 3 and 5 to 8

A three-dimensionally shaped product was obtained in a similar manner to Example 1 except that the type of the fiber sheet was changed to the fiber sheets illustrated in Table 2.

### Example 4

A three-dimensionally shaped product was obtained in a similar manner to Example 1 except that the type of the fiber sheet was changed to the fiber sheet 4, the number of the fiber layers was changed to two, the thickness of each of the first resin layer and the third resin layer was changed to 1.8 mm, the thickness of the second resin layer was changed to 0.9 mm, and the number of the resin layers was changed to three. The obtained three-dimensionally shaped product had a laminated structure of resin layer (1.8 mm)/fiber layer (0.2 mm)/resin layer (0.9 mm)/fiber layer (0.2 mm)/resin layer (1.8 mm).

### Example 9

A three-dimensionally shaped product was obtained in a similar manner to Example 4 except that the type of the fiber sheet was changed to the fiber sheet 9 and the thickness of each of the three resin layers was changed to 1.5 mm. The obtained three-dimensionally shaped product had a laminated structure of resin layer (1.5 mm)/fiber layer (0.24 mm)/resin layer (1.5 mm)/fiber layer (0.24 mm)/resin layer (1.5 mm).

### Example 10

A three-dimensionally shaped product was obtained in a similar manner to Example 1 except that the type of the fiber sheet was changed to the fiber sheet 10, the number of the fiber layers was changed to five, the number of the resin layers was changed to six, and the thickness of each of the resin layers was changed to 0.77 mm.

### Comparative Example 1

A three-dimensionally shaped product was obtained in a similar manner to Example 1 except that no fiber sheet was used.

### Comparative Example 2

Carbon fibers (average fiber length L: 35,000 nm, average fiber diameter T: 35 nm, aspect ratio L/T: 1,000) were dispersed in water to obtain a dispersion (suspension) containing 10.2% by mass of carbon fibers.

First, the prepared dispersion (suspension) was applied onto a support with a squeegee and then dried with hot air to obtain a layer containing carbon fibers and having a thickness of 0.1 mm. Subsequently, the prepared photocurable composition was ejected onto the obtained layer containing carbon fibers by an inkjet method. Thereafter, a predetermined region was irradiated with light, and the photocurable composition was cured to obtain a resin layer having a thickness of 0.9 mm. These steps were repeated to obtain a three-dimensionally shaped product.

The interlayer adhesiveness, the change in the amount of warpage after storage at a high temperature, the tensile strength, and the tensile elastic modulus of each of the three-dimensionally shaped products obtained in Examples 1 to 10 and Comparative Examples 1 and 2 were evaluated by the following methods.

(Interlayer Adhesiveness)

A fiber layer and a resin layer in the obtained three-dimensionally shaped product were peeled off from each other in a part of an interface therebetween. Thereafter, a T-type peeling strength test was performed with a measuring device: Tensilon universal testing machine RTC-1250A manufactured by A & D Company Limited under the following conditions, and adhesiveness between the fiber layer and the resin layer was measured.

Measurement temperature: 23° C. 50% RH

Tensile speed: 5 mm/min

(Amount of Change in Warpage after Storage at High Temperature)

The amount of warpage of the obtained strip-shaped three-dimensionally shaped product was measured. Subsequently, the three-dimensionally shaped product was stored under 80° C. 95% RH for 144 hours, and then the amount of warpage was measured similarly. The amount of warpage was taken as an average value of the heights of four corners from a surface of a table when the strip-shaped three-dimensionally shaped product was placed on the table.

Then, the amount of change in warpage before and after storage was measured and evaluated according to the following criteria.

A: The amount of change in warpage is less than 0.1 mm

B: The amount of change in warpage is 0.1 mm or more and less than 0.5 mm

C: The amount of change in warpage is 0.5 mm or more

(Tensile Strength and Tensile Elastic Modulus)

A dumbbell-shaped three-dimensionally shaped product (length: 170 mm, width: 20 mm, thickness: 5 mm, width of narrow portion: 10 mm, length of narrow portion: 80 mm) was manufactured under similar conditions to Examples and Comparative Examples. The tensile strength and the tensile elastic modulus of the three-dimensionally shaped product were measured according to JIS K 7161: 1994 (ISO 527: 1993) using a tensile tester (manufactured by Shimadzu Corporation, trade name: Autograph AG-X plus (R)). The tensile strength was measured at a tensile speed of 50 mm/min, and the tensile elastic modulus was measured at a tensile speed of 1 mm/min. The tensile direction was the length direction of the dumbbell-shaped three-dimensionally shaped product. Evaluation was performed according to the following criteria.

### (Tensile Strength)

A: Tensile strength is 200 MPa or more

B: Tensile strength is 100 MPa or more and less than 200 MPa

C: Tensile strength is 50 MPa or more and less than 100 MPa

D: Tensile strength is 30 MPa or more and less than 50 MPa

E: Tensile strength is less than 30 MPa

### (Tensile Elastic Modulus)

A: Tensile elastic modulus is 15.0 GPa or more

B: Tensile elastic modulus is 10.0 GPa or more and less than 15.0 GPa

C: Tensile elastic modulus is 5.0 GPa or more and less than 10.0 GPa

D: Tensile elastic modulus is 2.0 GPa or more and less than 5.0 GPa

E: Tensile elastic modulus is less than 2.0 GPa

Manufacturing conditions of Examples 1 to 10 and Comparative Examples 1 and 2 are illustrated in Table 2, and evaluation results thereof are illustrated in Table 3.

TABLE 2

| | | | Fiber sheet | | | | | |
|---|---|---|---|---|---|---|---|---|
| | | | | | | | Content of | Three-dimensionally |
| | | | | | | | fibrous | shaped product |
| | | Three-dimensional | | Fibrous | | Thickness | material (% by | Content of fibrous |
| | Shaping method | shaping composition | No. | material | Resin | (mm) | mass)*¹ | material (% by mass)*² |
| Example 1 | Material jetting | Photocurable | 1 | Carbon fiber | Epoxy resin | 0.1 | 10.5 | 1.58 |
| | method | composition | | | | | | |
| Example 2 | FDA | Thermoplastic resin | 2 | Carbon fiber | Epoxy resin | 0.1 | 11.1 | 1.67 |
| | | composition | | | | | | |
| Example 3 | Material jetting | Photocurable | 3 | Fluorine fiber | — | 0.1 | 10.2 | 1.53 |
| | method | composition | | | | | | |
| Example 4 | Material jetting | Photocurable | 4 | Carbon fiber | Epoxy resin | 0.2 | 21 | 1.58 |
| | method | composition | | | | | | |
| Example 5 | Material jetting | Photocurable | 5 | Carbon fiber | Epoxy resin | 0.1 | 29.1 | 4.37 |
| | method | composition | | | | | | |
| Example 6 | Material jetting | Photocurable | 6 | Carbon fiber | Epoxy resin | 0.1 | 35.2 | 5.28 |
| | method | composition | | | | | | |
| Example 7 | Material jetting | Photocurable | 7 | Carbon fiber | Epoxy resin | 0.1 | 5.2 | 0.78 |
| | method | composition | | | | | | |
| Example 8 | Material jetting | Photocurable | 8 | Carbon fiber | Thermoplastic | 0.1 | 10.5 | 1.58 |
| | method | composition | | | resin | | | |
| Example 9 | Material jetting | Photocurable | 9 | Carbon fiber | Epoxy resin | 0.24 | 25.2 | 1.90 |
| | method | composition | | | | | | |

TABLE 3

| | Evaluation | | | |
|---|---|---|---|---|
| | | Amount of change | | |
| | Interlayer | in warpage after | | Tensile |
| | adhesiveness | storage at high | Tensile | elastic |
| | (N/mm) | temperature | strength | modulus |
| Example 1 | 0.27 | A | B | A |
| Example 2 | 1.33 | B | B | B |
| Example 3 | 0.21 | A | B | C |
| Example 4 | 0.29 | A | B | A |
| Example 5 | 0.28 | A | B | A |
| Example 6 | 0.23 | B | A | A |
| Example 7 | 0.25 | B | B | B |
| Example 8 | 0.19 | A | B | A |
| Example 9 | 0.26 | B | B | A |
| Example 10 | 0.27 | A | B | B |
| Comparative | — | C | E | E |
| Example 1 | | | | |
| Comparative | 0.12 | C | D | E |
| Example 2 | | | | |

As illustrated in Table 3, it is found that each of the three-dimensionally shaped products of Examples 1 to 10 manufactured using a fiber sheet has high tensile strength and high tensile elastic modulus. It is considered that this is because fibers are continuously connected to each other in each of the three-dimensionally shaped products of Examples 1 to 10.

Meanwhile, the three-dimensionally shaped product of Comparative Example 2 in which a layer containing carbon fibers is formed in place of a fiber sheet has low tensile strength and low tensile elastic modulus similarly to the three-dimensionally shaped product of Comparative Example 1. It is considered that this is because fibers are not continuously connected to each other in the three-dimensionally shaped product of Example 2.

Among Examples 1 to 10, it is found that the three-dimensionally shaped product of Example 1 using carbon fibers has higher tensile strength and higher tensile elastic modulus than the three-dimensionally shaped product of Example 3 using fluorine fibers.

In addition, it is found that each of the three-dimensionally shaped products of Examples 2 and 6 has a larger amount of change in warpage after storage at a high temperature than the three-dimensionally shaped products of Examples 1, 3 to 5, and 7. In Example 2, the elastic modulus is low because the resin layer is constituted by a thermoplastic resin composition. In Example 6, the elastic modulus is high because the amount of carbon fibers contained in the fiber layer is large. It is considered that these are because a difference in elastic modulus between the resin layer and the fiber layer is increased.

In addition, it is found that the three-dimensionally shaped product of Example 6 using a fiber sheet having a large content of carbon fibers has slightly lower interlayer adhesiveness than the three-dimensionally shaped product of Example 1 using a fiber sheet having a moderate content of carbon fibers. In Example 6, it is considered that this is because the amount of carbon fibers contained in the fiber layer is too large.

In addition, it is found that the three-dimensionally shaped product of Example 1 using the fiber sheet No. 1 in which a resin contained in the fiber sheet is an “epoxy resin (thermosetting resin)” has slightly poorer interlayer adhesiveness but has a smaller amount of change in warpage after storage at a high temperature than the three-dimensionally shaped product of Example 8 using the fiber sheet No. 9 in which a resin contained in the fiber sheet is a “thermoplastic resin”. It is considered that this is because a difference in elastic modulus between the resin layer and the fiber layer is smaller in a case where a resin contained in the fiber layer is a thermosetting resin than in a case where a resin contained in the fiber layer is a thermoplastic resin.

In addition, it is found that the three-dimensionally shaped product of Example 1 using the fiber sheet No. 1 in which a resin contained in the fiber sheet is a “thermosetting resin” has higher interlayer adhesiveness than the three-dimensionally shaped product of Example 8 using the fiber sheet No. 9 in which a resin contained in the fiber sheet is a “thermoplastic resin”. It is considered that this is because a thermosetting resin contained in the fiber sheet has high affinity with the resin layer formed of a cured product of a photocurable composition.

In addition, comparison among Examples 1, 4, 9, and 10 indicates that each of the three-dimensionally shaped products of Examples 1 and 4 in which the thickness of the fiber sheet is 0.05 to 0.2 mm has a higher tensile strength than the three-dimensionally shaped product of Example 10 in which the thickness of the fiber sheet is thinner than 0.05 mm. It is considered that this is because the thickness of the fiber layer contained in each of the three-dimensionally shaped products of Examples 2 and 4 is moderately thick, and the strength is therefore moderately increased. Meanwhile, each of the three-dimensionally shaped products of Examples 1 and 4 in which the thickness of the fiber sheet is 0.05 to 0.2 mm has higher interlayer adhesiveness and less warpage after storage at a high temperature than the three-dimensionally shaped product of Example 9 in which the thickness of the fiber sheet is larger than 0.2 mm. It is considered that this is because the fiber sheet having a moderately thin thickness makes scattering of powder during laser processing less, thereby makes interlayer adhesiveness hardly impaired, does not excessively increase a difference in thermal shrinkage rate with the resin layer because the fiber layer is not too thick, and reduces warpage of a shaped product after storage at a high temperature.

The present application claims priority based on Japanese Patent Application No. 2016-72315 filed on Mar. 31, 2016. Contents described in the application specification and drawings are all incorporated herein by reference.

### INDUSTRIAL APPLICABILITY

The present invention can provide a method for manufacturing a three-dimensionally shaped product, capable of obtaining a three-dimensionally shaped product having a sufficient mechanical strength without reduction in a shaping speed.

### REFERENCE SIGNS LIST

10 Shaping stage
11 Fiber sheet
11-1, 11-2 Fiber layer
13 Photocurable composition
13-1, 13-2 Cured product layer (resin layer)
15 Three-dimensionally shaped product
100 Device for manufacturing three-dimensionally shaped product
110 Shaping stage
130 Fiber sheet supply mechanism
150 Head block
170 Moving mechanism
171 Main scanning direction guide
173 Sub-scanning direction guide
175 Vertical direction guide

1. A method for manufacturing a three-dimensionally shaped product, comprising the steps of:
cutting out a fiber sheet containing a fibrous material oriented in at least one direction into a predetermined shape to form a fiber layer; and
applying a three-dimensional shaping composition to a surface of the fiber layer and then solidifying the three-dimensional shaping composition to form a resin layer.

2. The method for manufacturing a three-dimensionally shaped product according to claim 1, wherein the fibrous material is a carbon fiber.

3. The method for manufacturing a three-dimensionally shaped product according to claim 1, wherein the fiber sheet further contains a resin with which the fibrous material is impregnated.

4. The method for manufacturing a three-dimensionally shaped product according to claim 3, wherein the resin is a thermosetting resin.

5. The method for manufacturing a three-dimensionally shaped product according to claim 1, wherein the content of the fibrous material is 10 to 30% by mass with respect to the total mass of the fiber sheet.

6. The method for manufacturing a three-dimensionally shaped product according to claim 1, wherein the fiber sheet has a thickness of 0.05 to 0.2 mm.

7. The method for manufacturing a three-dimensionally shaped product according to claim 1, wherein
the three-dimensional shaping composition is a photocurable composition, and
the step of forming the resin layer is a step of photocuring the photocurable composition applied to the fiber layer.

8. The method for manufacturing a three-dimensionally shaped product according to claim 1, wherein the fiber sheet is cut out by laser processing.

9. A device for manufacturing a three-dimensionally shaped product, comprising:
a shaping stage;
an ejecting unit for ejecting a three-dimensional shaping composition to the shaping stage;
a first moving mechanism for changing a relative position of the ejecting unit to the shaping stage;
a curing unit for curing the ejected three-dimensional shaping composition;
a supply mechanism for supplying a fiber sheet to the shaping stage;
a processing unit for cutting out the fiber sheet supplied onto the shaping stage into a predetermined shape; and
a second moving mechanism for changing a relative position between the processing unit and the shaping stage.

10. The method for manufacturing a three-dimensionally shaped product according to claim 2, wherein the fiber sheet further contains a resin with which the fibrous material is impregnated.

11. The method for manufacturing a three-dimensionally shaped product according to claim 2, wherein the content of the fibrous material is 10 to 30% by mass with respect to the total mass of the fiber sheet.

12. The method for manufacturing a three-dimensionally shaped product according to claim 2, wherein the fiber sheet has a thickness of 0.05 to 0.2 mm.

13. The method for manufacturing a three-dimensionally shaped product according to claim 2, wherein
the three-dimensional shaping composition is a photocurable composition, and
the forming the resin layer is photocuring the photocurable composition applied to the fiber layer.

14. The method for manufacturing a three-dimensionally shaped product according to claim 2, wherein the fiber sheet is cut out by laser processing.

15. The method for manufacturing a three-dimensionally shaped product according to claim 3, wherein the content of the fibrous material is 10 to 30% by mass with respect to the total mass of the fiber sheet.

16. The method for manufacturing a three-dimensionally shaped product according to claim 3, wherein the fiber sheet has a thickness of 0.05 to 0.2 mm.

17. The method for manufacturing a three-dimensionally shaped product according to claim 3, wherein
the three-dimensional shaping composition is a photocurable composition, and
the forming the resin layer is photocuring the photocurable composition applied to the fiber layer.

18. The method for manufacturing a three-dimensionally shaped product according to claim 3, wherein the fiber sheet is cut out by laser processing.

19. The method for manufacturing a three-dimensionally shaped product according to claim 4, wherein the content of the fibrous material is 10 to 30% by mass with respect to the total mass of the fiber sheet.

20. The method for manufacturing a three-dimensionally shaped product according to claim 4, wherein the fiber sheet has a thickness of 0.05 to 0.2 mm.
